(19) United States
(12) Patent Application Publication
(10) Pub. No.: US 2010/0199220 A1
(43) Pub. Date: Aug. 5, 2010

(54) IMAGE INFORMATION ACQUISITION DEVICE, ITS METHOD, AND PROGRAM

(75) Inventors: Norihide Tanichi, Osaka-shi (JP); Goro Kondo, Osaka-shi (JP)

Correspondence Address: SUGHRUE MION, PLLC, 2100 PENNSYLVANIA AVENUE, N.W., SUITE 800, WASHINGTON, DC, 20037, US

(73) Assignee: Yomiuri Telecasting Corporation, Osaka-shi, Osaka (JP)

(21) Appl. No.: 12/602,332

(22) PCT Filed: May 27, 2008
(86) PCT No.: PCT/JP2008/059722

§ 371 Date: Nov. 30, 2009

(30) Foreign Application Priority Data
May 29, 2007 (JP) 2007-142566

(51) Int. Cl. G06F 3/048

(52) U.S. Cl. 715/838

(57) ABSTRACT

A dynamic image acquisition device includes: input means (12) for inputting a keyword; dynamic image information acquisition means (14) which accesses a dynamic image site and acquires a dynamic image identifier containing the keyword and the address of the link destination of the dynamic image; thumbnail display means (15) which acquires dynamic image thumbnail data according to the acquired address and displays a dynamic image thumbnail; selection means (12, 15) for selecting the thumbnail of the displayed dynamic image; storage means (16) for storing the identifier of the dynamic image of the selected thumbnail; and a mail generation unit (17) for generating a mail for requesting the dynamic image site to delete the selected dynamic image.

### TECHNICAL FIELD

The present invention relates to an image information acquisition apparatus, and a method and a program for the same, and particularly to an image information acquisition apparatus, and a method and a program for the same for automatically acquiring identification numbers of illegal moving pictures or still images from a moving picture site or the like.

### BACKGROUND ART

In recent years, moving picture upload sites, such as those represented by YouTube (see Non-patent Document 1), get rapidly increasing accesses up to ten millions from Japan in February, 2007. In the first place, moving picture upload sites are provided for users to upload videos captured using home video cameras or the like. However, there are currently found numerous moving pictures from recorded TV programs or commercially available DVD's intactly uploaded without permission, and these moving pictures may infringe a copyright, impairing the benefit of copyright holders.

Although moving picture upload sites themselves also prohibit uploading of files leading to copyright infringement by their agreements for use, uploading of such files leading to copyright infringement currently still continues.

In view of such circumstances, an attempt has been currently made by copyright holders or people in charge in copyright control organizations to take an action against the infringement by reviewing a moving picture site to find illegal moving pictures, acquiring ID's (identification information pieces) of the moving pictures one by one, and reporting the ID's to an administrator of the moving picture site to make a delete request.

Non-Patent Document 1: “http://www.youtube.com/”

### DISCLOSURE OF THE INVENTION

### Problems to be Solved by the Invention

While moving picture sites delete corresponding moving pictures in response to the delete request, there are a tremendous number of illegal moving pictures uploaded to the sites, and acquisition of ID's of the illegal moving pictures is extremely labor- and time-consuming.

The present invention has been made in view of such a problem, and its object is to provide image information acquisition apparatuses, and methods and programs for the same capable of automatically acquiring identification information for illegal moving pictures and still images from moving picture sites and the like.

### Means to Solve the Problem

The present invention for solving the above-mentioned is an image information acquisition apparatus comprising: input means for inputting a keyword; image information acquiring means for accessing an image site and acquiring identification information for an image relevant to said keyword and an address linked to said image; thumbnail display means for acquiring a thumbnail data for the image based on said acquired address and displaying a thumbnail of the image; selecting means for selecting the displayed thumbnail of the image; storage means for storing therein identification information for the image of said selected thumbnail; and mail creating means for creating a delete request mail in which identification information for said selected image and a delete request statement for requesting deletion of said selected image are described.

The present invention for solving the above-mentioned is an image information acquisition method of acquiring image information from an image site, comprising: image information acquisition processing of accessing an image site, and acquiring identification information for an image containing a keyword that has been input and an address linked to said image; thumbnail display processing of acquiring a thumbnail data for the image based on said acquired address and displaying thumbnails of the image; image identification information storing processing of allowing a user to select a predetermined thumbnail from the displayed thumbnails of the image, and storing identification information for an image of said selected thumbnail; and image delete request mail generating processing of creating an image delete request mail in which identification information for said selected image and a delete request statement for requesting deletion of said selected image are described.

The present invention for solving the above-mentioned is a program for an information processing apparatus, wherein the program causes the information processing apparatus to execute: image information acquisition processing of accessing an image site, and acquiring identification information for an image containing a keyword that has been input and an address linked to said image; thumbnail display processing of acquiring a thumbnail data for the image based on said acquired address and displaying thumbnails of the image; image identification information storing processing of allowing a user to select a predetermined thumbnail from the displayed thumbnails of the image, and storing identification information for an image of said selected thumbnail; and image delete request mail generating processing of creating an image delete request mail in which identification information for said selected image and a delete request statement for requesting deletion of said selected image are described.

### EFFECTS OF THE INVENTION

According to the present invention, identification information for moving pictures can be automatically acquired from moving picture sites to check illegal moving pictures, and moreover, a mail for a delete request can be automatically created.

### BRIEF DESCRIPTION OF THE DRAWINGS

FIG. 1 is a diagram for explaining an embodiment of the present invention.

FIG. 2 is a block diagram of an information processing apparatus 1.

FIG. 3 is a diagram for explaining the embodiment of the present invention.

FIG. 4 is a diagram for explaining the embodiment of the present invention.

FIG. 5 is a diagram for explaining the embodiment of the present invention.

FIG. 6 is a diagram for explaining a second embodiment of the present invention.

FIG. 7 is a diagram for explaining a third embodiment of the present invention.

FIG. 8 is a diagram for explaining a fourth embodiment the present invention.

FIG. 9 is a diagram for explaining a fifth embodiment of the present invention.

### EXPLANATION OF SYMBOLS

1 Information processing apparatus
2 Server
3 Network
11 Transmitting/receiving section
12 Keyboard
13 Display
14 Moving pictures information acquiring section
15 Thumbnail display section
16 Storage section
17 Mail creating section
20 Matching section
30 Illegal moving picture detecting section
40 Deletion confirming section
50 Image keyword acquiring section

### BEST MODES FOR CARRYING OUT THE INVENTION

Now several embodiments of the present invention will be described. While the present invention may be generally applied to all kinds of images, not limited to moving pictures or still images, the following description will be directed to a case of moving pictures.

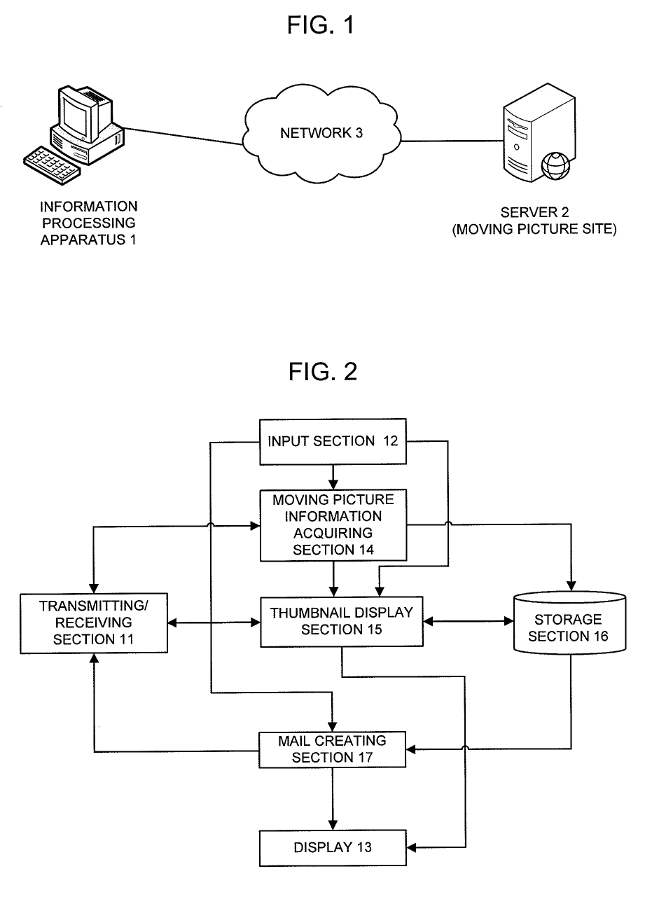

FIG. 1 is a diagram for explaining an embodiment of the present invention.

In FIG. 1, reference numeral 1 designates an information processing apparatus for finding illegal moving pictures, reference numeral 2 designates a server at a moving picture site, and reference numeral 3 designates a network. The information processing apparatus 1 can access a moving picture web site in the server 2 via the network 3.

FIG. 2 is a block diagram of the information processing apparatus 1. The information processing apparatus 1 comprises a transmitting/receiving section 11, a keyboard 12, a display 13, a moving picture information acquiring section 14, a thumbnail display section 15, a storage section 16, and a mail creating section 17.

The moving picture information acquiring section 14 accesses the server 2 at a selected moving picture site, and acquires identification information (assigned at the moving picture site; referred to as moving picture ID hereinbelow) for a moving picture relevant to a keyword for a moving picture input via the keyboard 12, and a URL of a thumbnail image of the moving picture. The acquired moving picture ID and URL of the thumbnail image are sent to the thumbnail display section 15. The moving picture ID is also stored in the storage section 16.

Specifically, a moving picture ID of a moving picture and a URL (location of an image on an internet) of its thumbnail image are automatically acquired according to the following procedure:

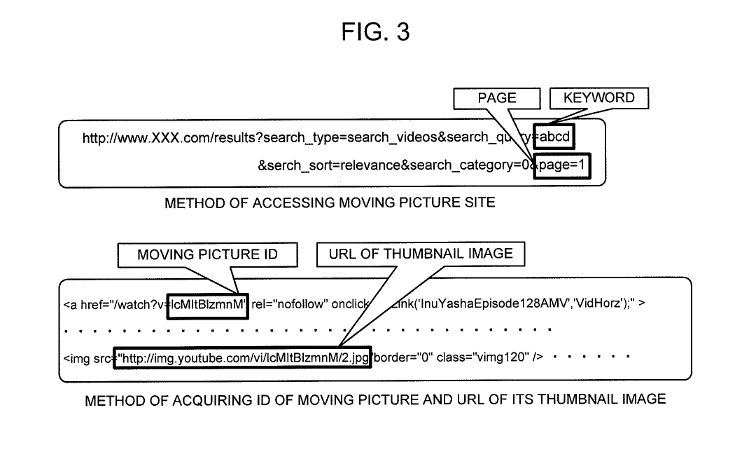

(1) As exemplarily shown in FIG. 3, a keyword “abed,” for example, and page 1 are specified to access a moving picture site and get a source code.

(2) The source code is analyzed to acquire a predetermined number of moving picture ID's and URL's of thumbnail images for the moving pictures in page 1.

(3) In a similar manner, page 2, page 3, . . . are accessed to acquire moving picture ID's and URL's of thumbnail images.

(4) The acquired moving picture ID's and URL's of thumbnail images are sent to the thumbnail display section 15. The moving picture ID's are also stored in the storage section 16.

The moving picture information acquiring section 14 may be provided with a timer function. The timer function may allow for acquisition of moving picture ID's for moving pictures relevant to a keyword for a moving picture input via the keyboard 12 and URL's of their thumbnail images in a certain periodic cycle.

On receipt of the moving picture ID's and URL's of the moving pictures from the moving picture information acquiring section 14, the thumbnail display section 15 downloads thumbnail images of the moving pictures relevant to the keyword from the moving picture site and displays them on the display 13.

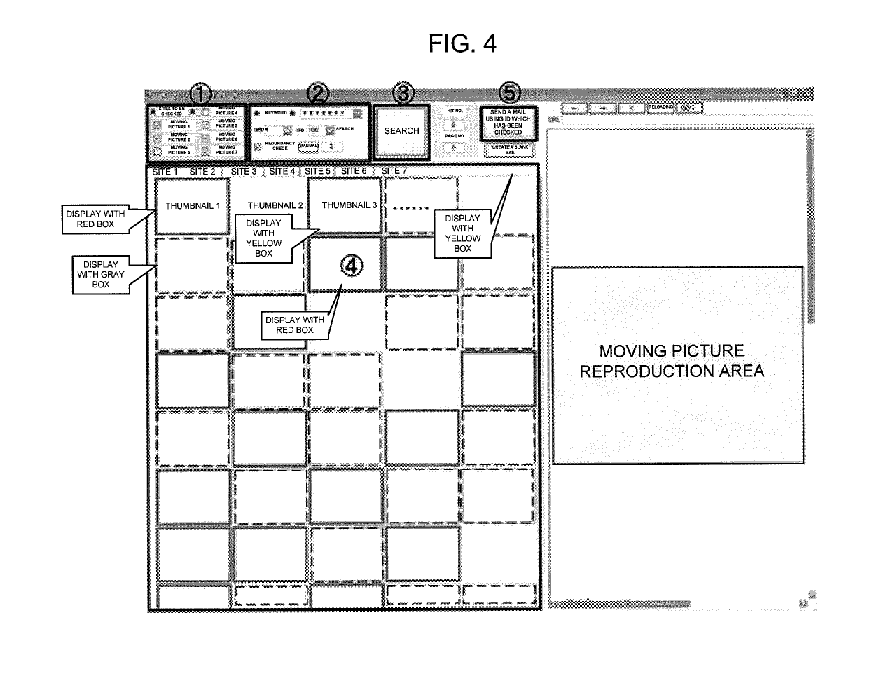

An example of a screen display on the display 13 by the moving picture information acquiring section 14 and thumbnail display section 15 is shown in FIG. 4.

In FIG. 4, the display is divided into three areas: a specification area, a search result display area, and a moving picture reproduction area.

First, moving picture upload sites to be checked are defined in a moving picture upload site specification area (1), a keyword is defined in a keyword specification area (2), and a search start button (3) is pressed, upon which the moving picture information acquiring section 14 starts searching. Then, the thumbnail display section 15 sequentially displays thumbnail images in a thumbnail image display area (4).

The thumbnail display section 15 is configured to display the acquired thumbnail images while assigning them to respective buttons, as shown in FIG. 4, allowing a user to choose and click on a button of a thumbnail image, and thereby select an illegal moving picture by surrounding the thumbnail image with a red box.

Moreover, the thumbnail display section 15 has a function to reproduce a corresponding moving picture when a certain one of the thumbnail images is selected by the user via the keyboard 12. Specifically, as shown in FIG. 4, the thumbnail display section 15 is configured to display acquired thumbnail images while assigning them to respective buttons, and when a button of a thumbnail image is double-clicked on, make the thumbnail image discernible by surrounding it with a yellow box, and reproduce its corresponding moving picture. This is because it may be sometimes difficult to decide whether the moving picture is illegal or not merely from the thumbnail image.

When a moving picture is selected as an illegal moving picture, the thumbnail display section 15 stores its moving picture ID in the storage section 16.

The mail creating section 17 stores therein a template for requesting a moving picture site for deletion, creates a mail containing the template and moving picture ID's of the moving pictures stored in the storage section 16 for a delete request, and sends the created mail to a previously stored destination of the moving picture site.

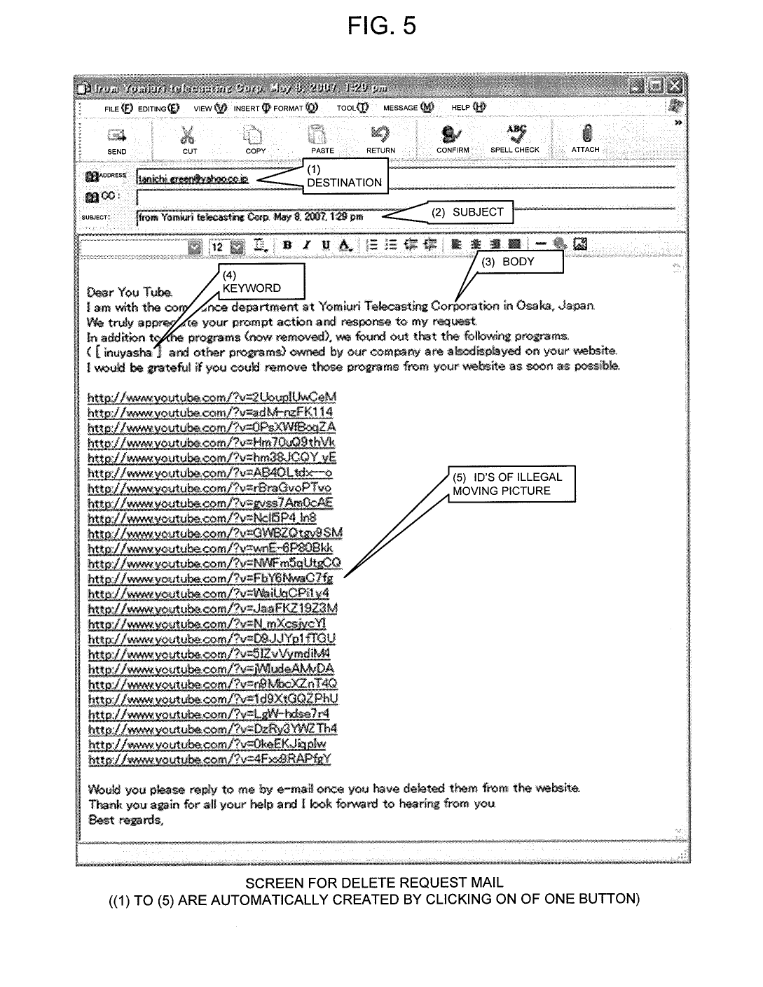

FIG. 5 shows an example of a mail created by the mail creating section 17.

Next, an operation to create a mail of a delete request for illegal moving pictures will be specifically described.

First, a check of illegal moving pictures will be described in detail. Upon clicking on of a thumbnail image in search results, a box around the button is turned into red to indicate a mark of an illegal moving picture. Ordinarily, most illegal moving pictures can be decided to be illegal only with their thumbnail images. However, there indeed are cases in which decision cannot be made merely with the thumbnail images, and thus, a thumbnail image is double-clicked on to turn the box into yellow and reproduce its corresponding moving picture in the moving picture reproduction area shown in the right of FIG. 4.

When a moving picture is decided to be illegal by reviewing it, the moving picture is clicked on once more to turn the box into red. In other words, only moving pictures with red boxes are decided to be illegal and those with yellow and gray boxes are decided not to be illegal, and when creating a mail, only moving picture ID's with red boxes are extracted and inserted into the body of the mail.

Upon a press on a button indicating “Send a mail containing checked moving picture ID's” (indicated by (5) in FIG. 4), a delete request mail to be sent to the moving picture upload site is created as shown in FIG. 5, with automatically inserted destination (1), subject (2), body (3), keyword (4), and moving picture ID's of illegal moving pictures (5). Upon a press on a send button, the mail is sent to the destination of the mail.

It should be noted that the mail creating section 17 may create a delete request mail once a certain condition has been satisfied. For example, the mail creating section 17 may be configured to create and send a delete request mail when a condition that there are newly found one hundred or more moving pictures relevant to a certain keyword is satisfied.

By such a configuration, a work from acquisition of moving picture ID's of potentially illegal moving pictures to creation of a delete request mail for illegal moving pictures can be significantly streamlined.

Next, a second embodiment will be described below.

Although a search is made once with a predetermined keyword and moving pictures to be listed in a delete request are checked, one or more of them may be thereafter excluded from the delete request because they are decided not to be illegal; even in this case, such moving pictures will remain hit as moving pictures to be checked again by another search with the same keyword. Such a work involving checking moving pictures for a delete request from among those including the once-excluded moving pictures is ineffective.

Accordingly, the second embodiment is configured to prevent moving pictures that were found once in the past with a predetermined keyword, and checked whether they are to be listed in a delete request but decided not to be illegal, from being listed for a check of illegal moving pictures again.

To achieve such a function, the second embodiment is configured such that the thumbnail display section 15 checks an illegal moving picture, and for a moving picture that is decided not to be illegal, saves its moving picture ID in the storage section 16.

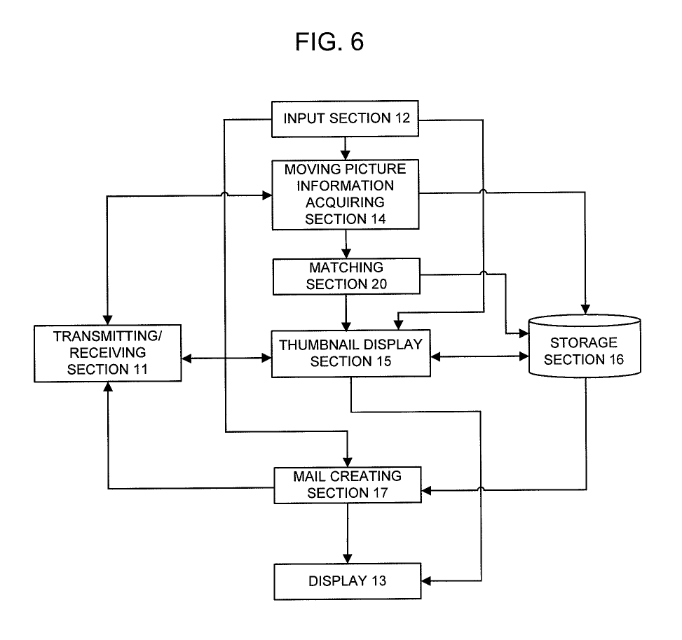

Moreover, as shown in FIG. 6, the information processing apparatus 1 includes a matching section 20. The matching section 20 compares a moving picture ID newly acquired in a search with a moving picture ID stored in the storage section 16, and prevents a moving picture ID and a URL of its thumbnail image for a moving picture having an already saved moving picture ID from being sent to the thumbnail display section 15.

By such a configuration, moving pictures that were checked once whether they were illegal but decided to be illegal are prevented from being hit as moving pictures to be checked in a search thereafter, and thus, an ineffective work can be eliminated.

Now a third embodiment will be described below.

While a manual check of illegal moving pictures is addressed in the aforementioned embodiments, the third embodiment is configured to automatically detect illegal moving pictures based on information on acquired moving pictures.

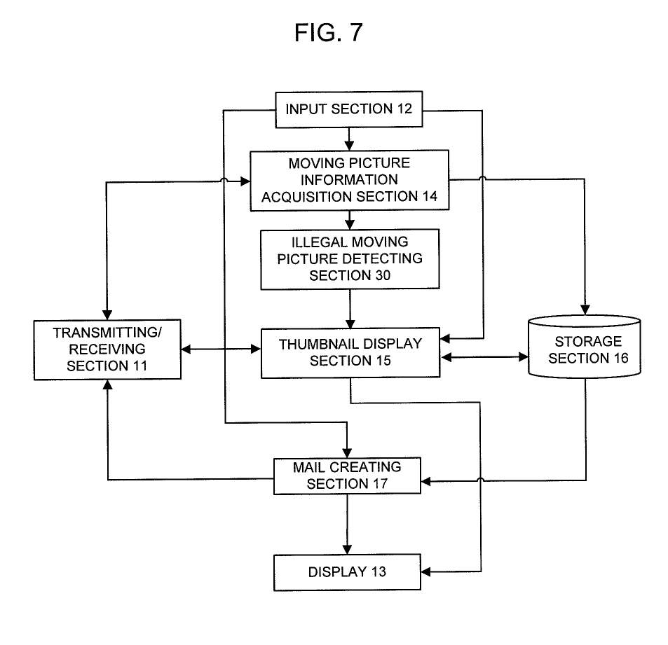

FIG. 7 is a block diagram of the third embodiment.

As shown in FIG. 7, it comprises an illegal moving picture detecting section 30 in addition to the components in the first embodiment.

The illegal moving picture detecting section 30 acquires a moving picture on receipt of a moving picture ID and a URL of the moving picture from the moving picture information acquiring section 14, and detects an illegal moving picture based on the moving picture. One method of detecting illegal moving pictures involves using electronic watermark information embedded in the moving picture. The electronic watermark information embedded in a moving picture generally contains information on the copyright holder, etc. of the moving picture. Therefore, the illegal moving picture detecting section 30 can identify a person who uploaded the moving picture and relevance between the site at which the moving picture is uploaded and the original copyright holder, etc. by detecting the electronic watermark information from the acquired image, and decide one having no relevance as an illegal moving picture.

Another method of detecting illegal moving pictures involves image recognition of an acquired moving picture to detect an illegal moving picture. Methods of image recognition include one involving recognizing a logo of a broadcaster or a superposed clock displayed in an image, and deciding the image as illegal when they are detected. Other methods of image recognition include a method involving constructing a database containing moving pictures that have been decided to be illegal once, and when the same moving picture is uploaded, deciding identity from characteristics of the moving picture to detect an illegal image; and a method involving constructing a database containing images provided by a copyright holder of the moving picture, and deciding identity from characteristics of the images in the database and those of an acquired image to detect an illegal image, although the present invention is not limited thereto.

On receipt of a moving picture ID and a URL of the moving picture, and a detection result of an illegal image from the illegal moving picture detecting section 30, the thumbnail display section 15 displays a thumbnail image for the moving picture relevant to the keyword along with the detection result of the illegal image on the display 13. The method of displaying the detection result may involve turning a display box for the thumbnail image into red when it is decided to be illegal.

While the aforementioned examples address detection of illegal images using an electronic watermark or image recognition using an image, it is possible to detect illegal images using identification information for a user who uploaded the image, as well as using an image. This is based on the fact that a user who uploaded any one illegal moving picture is highly likely to be a repeated offender. Accordingly, a list of identification information for such users is constructed and moving pictures uploaded by such users are listed for checking. Moreover, a user who uploaded an illegal moving picture only once in the past may also be subjected to similar processing. It should be noted that there may be a case in which a copyright holder uploads a moving picture by himself/herself in alliance with the moving picture site under a copyright; in that case, such information may be acquired beforehand to allow the moving picture to be excluded from a list of user identification information to be checked.

By thus automating detection of illegal images, the process may be further streamlined.

A fourth embodiment will be described below.

While the first embodiment addresses creation of a delete request mail for an illegal moving picture by the mail creating section 17, in the fourth embodiment, a case in which follow-up survey is additionally made as to whether an illegal moving picture has been deleted in response to a delete request for the illegal moving picture will be described.

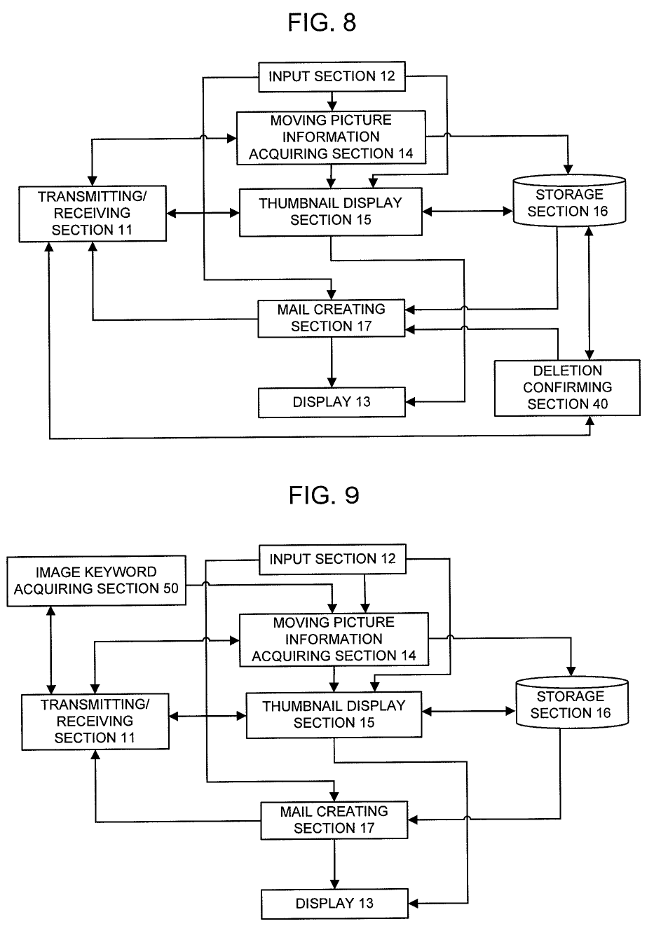

FIG. 8 is a block diagram of the fourth embodiment.

As shown in FIG. 8, it comprises a deletion confirming section 40 in addition to the components in the first embodiment.

The deletion confirming section 40 reads a moving picture ID of an illegal moving picture stored in the storage section 16 by the thumbnail display section 15, and makes follow-up survey as to whether the moving picture corresponding to the moving picture ID has been deleted, after a certain period of time (e.g., after three days) from a delete request mail sent by the mail creating section 17. A method of follow-up survey may involve the following steps: when accessing a moving picture site with a specification of a moving picture ID for a moving picture, the moving picture site displays a “black screen,” a message “This moving picture has been deleted by the copyright processor,” or “Browser error: Page not found” in a case that the moving picture corresponding to the moving picture ID has been deleted. Therefore, such a display is stored beforehand and when such a display is found by image processing, the moving picture can be decided to be deleted in response to a delete request. In a case that the moving picture has been deleted, the moving picture ID for the moving picture stored in the storage section 16 is deleted. In a case that a moving picture site is accessed with a specification of a moving picture ID for a moving picture and the moving picture having the moving picture ID is reproduced, the moving picture ID is reported to the mail creating section 17. The mail creating section 17 then creates a delete request mail for the moving picture having the moving picture ID and sends it out.

It is also possible to store properties of an image having a moving picture ID of an illegal moving picture in the deletion confirming section 40 to decide deletion based on the properties of the moving picture.

A fifth embodiment will be described below.

In recent years, there are found an increasing number of malignant users of upload sites, who often make an attempt to upload moving pictures with a title or subject having a misleading keyword, rather than those directly representing the title or content of the image, in order to avoid the risk of exposure.

The fifth embodiment is configured to allow detection of illegal moving pictures even with misleading titles or subjects as described above.

FIG. 9 is a block diagram of the fifth embodiment.

As shown in FIG. 9, it comprises an image keyword acquiring section 50 in addition to the components in the first embodiment.

When an image is uploaded to a moving picture site with a keyword irrelevant to the title or content of the image, no one can find the image using such a keyword; and therefore, the uploader often writes relevance of a specific title, subject or the like of the uploaded moving picture with the keyword into bulletin boards or community sites. Accordingly, the image keyword acquiring section 50 stores beforehand information on keywords of a moving picture possibly vulnerable to illegal uploading, including a title, subject, characters or the like, and searches bulletin boards or community sites in a certain periodic cycle. It searches the bulletin boards or community sites for a sentence including the keyword information, and when a sentence stating that the moving picture is uploaded to a moving picture upload site with a keyword different from the keyword information is found, passes the moving picture moving picture upload site and keyword to the moving picture information acquiring section 14. For example, in a case that the image keyword acquiring section 50 stores therein as “famous detective AAA” as keyword information and there is found a sentence “the moving picture ‘The Famous Detective AAA’ has been uploaded with a keyword ‘BBBB’ on an upload site XXX” in a bulletin board, the image keyword acquiring section 50 passes the upload site XXX and a keyword “BBBB” to the moving picture information acquiring section 14.

Based on the information acquired from the image keyword acquiring section 50, the moving picture information acquiring section 14 accesses the server 2 at the moving picture site and acquires a moving picture ID of a moving picture relevant to the acquired keyword and a URL of a thumbnail image of the moving picture. It then sends the acquired moving picture ID and URL of its thumbnail image to the thumbnail display section 15. For example, when an upload site XXX and a keyword BBBB are acquired from the image keyword acquiring section 50, it accesses the upload site XXX, and acquires a moving picture ID of a moving picture relevant to the keyword BBBB and a URL of a thumbnail image of the moving picture.

While the foregoing description of the embodiments addresses the information processing apparatus configured by hardware, an ordinary computer may be used to practice the invention by a program causing a CPU or the like to perform an operation similar to that described above in the embodiments.

It should also be noted that the first to fifth embodiments may be configured in combination as appropriate.

1. An image information acquisition apparatus comprising:
input means for inputting a keyword;
image information acquiring means for accessing an image site and acquiring identification information for an image relevant to said keyword and an address linked to said image;
thumbnail display means for acquiring a thumbnail data for said image based on said acquired address and displaying a thumbnail of said image;
selecting means for selecting the displayed thumbnail of the image;
storage means for storing therein identification information for said image corresponding to said selected thumbnail; and
mail creating means for previously storing therein a template for requesting for deletion of an image, inserting the identification information of said image stored in said storage means into said template, and creating a delete request mail for requesting said image site for deletion of said selected image.

2. An image information acquisition apparatus according to claim 1, comprising:
storage means for storing therein identification information for an image that is not selected,
wherein said thumbnail display means compares identification information for a newly acquired image with that for said stored image that is not selected, and excludes an image having the same identification information from a display of thumbnails.

3. An image information acquisition apparatus according to claim 1, wherein said image information acquiring means is configured to acquire resources in the image site, and acquire identification information for an image and an address linked to the image from the resources including said keyword.

4. An image information acquisition apparatus according to claim 1, wherein said image is a moving picture.

5. A moving picture information acquisition apparatus according to claim 4, wherein said thumbnail display means comprises reproduction means for reproducing a moving picture of the image of the selected thumbnail.

6. An image information acquisition apparatus according to claim 1, comprising illegal image detecting means for detecting an illegal image based on information in the image acquired by said image information acquiring means.

7. An image information acquisition apparatus according to claim 1, comprising deletion confirming means for confirming whether the image for which a delete request has been made is deleted in the image site to which said delete request mail has been sent.

8. An image information acquisition apparatus according to claim 1, comprising:
image keyword acquiring means for referring to other sites and acquiring a keyword of an image uploaded to an image site,
wherein said image information acquiring means acquires identification information for an image relevant to the keyword acquired by said image keyword acquiring means, and an address linked to said image.

9. An image information acquisition method of acquiring image information from an image site, comprising:
image information acquisition processing in which an information processing apparatus accesses an image site, and acquires identification information for an image relevant to a keyword that has been input by a user and an address linked to said image;
thumbnail display processing in which the information processing apparatus acquires a thumbnail data for said image based on said acquired address and displays a thumbnail of said image;
image identification information storing processing in which the information processing apparatus stores identification information for said image corresponding to the thumbnail selected by a user from the displayed thumbnail of the image; and
image delete request mail creating processing in which the information processing apparatus inserts the identification information of said image stored by said image identification information storing processing into a previously stored template for requesting for deletion of the image, and creates an image delete request mail for requesting said image site for deletion of said selected image.

10. An image information acquisition method according to claim 9, comprising:
processing in which the information processing apparatus stores identification information for an image that is not selected by a user; and
processing in which the information processing apparatus compares identification information for a newly acquired image with that for said stored image that is not selected, and excludes an image having the same identification information from a display of thumbnails.

11. An image information acquisition method according to claim 9, wherein, in said image information acquisition processing, the information processing apparatus acquires resources of an image site, and acquires identification information for an image and an address linked to the image from the resources containing said keyword.

12. An image information acquisition method according to claim 9, wherein said image is a moving picture.

13. An image information acquisition method according to claim 12, wherein, in said thumbnail display processing, the information processing apparatus comprises processing of reproducing a moving picture displayed in thumbnails.

14. An image information acquisition method according to claim 9, wherein the information processing apparatus comprises illegal image detection processing of detecting an illegal image based on information in the image acquired by said image information acquisition processing.

15. An image information acquisition method according to claim 9, wherein the information processing apparatus comprises deletion confirmation processing of confirming whether the image for which a delete request has been made is deleted in the image site to which said delete request mail has been sent.

16. An image information acquisition method according to claim 9, wherein the information processing apparatus comprises image keyword acquiring processing of referring to other sites and acquiring a keyword of an image uploaded to an image site, and
said image information acquisition processing comprises acquiring identification information for an image relevant to the keyword acquired by said image keyword acquiring processing, and an address linked to said image.

17. A program for an information processing apparatus, wherein the program causes the information processing apparatus to execute:
image information acquisition processing of accessing an image site, and acquiring identification information for an image relative to a keyword that has been input by a user and an address linked to said image;
thumbnail display processing of acquiring a thumbnail data for said image based on said acquired address and displaying a thumbnail of said image;
image identification information storing processing of storing identification information for said image corresponding to the thumbnail selected by a user from the displayed thumbnail of the image; and
image delete request mail creating processing of inserting the identification information of said image stored by said image identification information storing processing into a previously stored template for requesting for deletion of the image, and creating an image delete request mail for requesting said image site for deletion of said selected image.

18. A program according to claim 17, wherein the program causes the information processing apparatus to execute the processing of:
storing identification information for an image that is not selected by a user; and
comparing identification information for a newly acquired image with that for said stored image that is not selected, and excluding an image having the same identification information from a display of thumbnails.

19. A program according to claim 17, wherein, in said image information acquisition processing, the information processing apparatus acquires resources of an image site, and acquires identification information for an image and an address linked to the image from the resources containing said keyword.

20. A program according to claim 17, wherein said image is a moving picture.

21. A program according to claim 20, wherein, in said thumbnail display processing, the information processing apparatus comprises processing of reproducing a moving picture displayed in thumbnails.

22. A program according to claim 17, wherein the information processing apparatus comprises illegal image detection processing of detecting an illegal image based on information in the image acquired by said image information acquisition processing.

23. A program according to claim 17, wherein the information processing apparatus comprises deletion confirmation processing of confirming whether the image for which a delete request has been made is deleted in the image site to which said delete request mail has been sent.

24. A program according to claim 17, wherein the program causes the information processing apparatus to execute:
image keyword acquiring processing of referring to other sites and acquiring a keyword of an image uploaded to an image site, and
in said image information acquisition processing, the information processing apparatus acquires identification information for an image relevant to the keyword acquired by said image keyword acquiring processing, and an address linked to said image.
